(19) United States
(12) Patent Application Publication
(10) Pub. No.: US 2026/0164177 A1
(43) Pub. Date: Jun. 11, 2026

(54) METHODS, SYSTEMS, AND MEDIA FOR PROVIDING SPATIAL AUDIO BY SYNCHRONIZING OUTPUT AUDIO FROM ONE OR MORE SPEAKER DEVICES TO INPUT AUDIO FROM A DIRECTIONAL AUDIO SOURCE

(71) Applicant: Google LLC, Mountain View, CA (US)

(72) Inventor: Dongeek Shin, San Jose, CA (US)

(21) Appl. No.: 19/129,483

(22) PCT Filed: Nov. 14, 2022
(86) PCT No.: PCT/US2022/049802

§ 371 Date: May 13, 2025

(51) Int. Cl. H04R 3/12; H04R 1/40; H04R 3/00

(52) U.S. Cl. CPC H04R 3/12; H04R 1/403; H04R 1/406; H04R 3/005; H04R 2203/12; H04R 2420/07; H04R 2430/23

(57) ABSTRACT

Methods, systems, and media for providing spatial audio by synchronizing output audio from one or more speaker devices to input audio from a directional audio source are provided. In some implementations, a method for providing spatial audio is provided that includes: receiving, from a microphone of a plurality of microphones associated with an electronic speaker device that is not paired with a media device, a plurality of microphone signals that are responsive to input audio being provided by the media device; performing directional processing on the plurality of microphone signals to produce an audio signal that corresponds with the input audio being provided by the media device; amplifying the audio signal to generate an amplified signal; and, while receiving the plurality of microphone signals, generating output audio using at least one speaker associated with the electronic speaker device in response to the amplified signal.

### TECHNICAL FIELD

The disclosed subject matter relates to methods, systems, and media for providing spatial audio by synchronizing output audio from one or more speaker devices to input audio from a directional audio source.

### BACKGROUND

Modern audio-visual experiences include features such as room-wide spatial audio while streaming content from a television device. One common way to achieve this is to use external speakers connected to the television device, either using a wired connection or a wireless connection (e.g., Bluetooth).

Such configurations, however, are not always available to users. For example, the television device may not be capable of wireless pairing. As another example, the television device may have a maximum number of speaker connection ports (either wired or wireless) that limit the user's ability to implement enough speakers for a spatial audio experience. Additionally, wireless speaker connections can, at times, be unreliable (e.g. where packets are dropped due to interference), thereby creating a frustrating audio streaming experience for the user.

Accordingly, it is desirable to provide new methods, systems, and media for providing spatial audio by synchronizing output audio from one or more speaker devices to input audio from a directional audio source.

### SUMMARY

In accordance with some implementations of the disclosed subject matter, methods, systems, and media for providing spatial audio by synchronizing output audio from one or more speaker devices to input audio from a directional audio source are provided.

In accordance with some implementations of the disclosed subject matter, a method for providing spatial audio is provided, the method comprising: receiving, from a microphone of a plurality of microphones associated with an electronic speaker device that is not paired with a media device, a plurality of microphone signals that are responsive to input audio being provided by the media device; performing directional processing on the plurality of microphone signals to produce an audio signal that corresponds with the input audio being provided by the media device; amplifying the audio signal to generate an amplified signal; and, while receiving the plurality of microphone signals, generating output audio using at least one speaker associated with the electronic speaker device in response to the amplified signal.

In some implementations, generating the output audio using the at least one speaker associated with the electronic device in response to the amplified signal further comprises selecting a speaker from a plurality of speakers that are included in the electronic speaker device.

In some implementations, generating the output audio using the at least one speaker associated with the electronic device in response to the amplified signal further comprises: determining a beamformed signal from the amplified signal that corresponds with a listening zone in an environment that includes the media device and the electronic speaker device; and causing a plurality of speakers within the electronic speaker device to produce the output audio corresponding to the beamformed signal.

In some implementations, performing directional processing further comprises performing a first weighted delay and sum calculation on the plurality of microphone signals to separate the input audio being provided by the media device from background audio signals. In some implementations, the first weighted delay and sum calculation further comprises complex valued weights comprising an amplitude and a phase. In some implementations, the first weighted delay and sum calculation further comprises weights determined in a second weighted delay and sum calculation.

In some implementations, the input audio comprises a set of audio tones produced from one or more locations, and wherein the method further comprises: in response to performing directional processing on the plurality of microphone signals to produce the audio signal, causing a plurality of weights to be determined, wherein the plurality of weights correspond to the one or more locations; and causing the plurality of weights to be stored in the electronic speaker device.

In accordance with some implementations of the disclosed subject matter, an electronic speaker device that provides spatial audio is provided, wherein the electronic speaker device comprises a plurality of microphones, a plurality of speakers, and a hardware processor that is configured to: receive, from a microphone of the plurality of microphones associated with the electronic speaker device that is not paired with a media device, a plurality of microphone signals that are responsive to input audio being provided by the media device; perform directional processing on the plurality of microphone signals to produce an audio signal that corresponds with the input audio being provided by the media device; amplify the audio signal to generate an amplified signal; and, while receiving the plurality of microphone signals, generate output audio using at least one speaker associated with the electronic speaker device in response to the amplified signal.

In accordance with some implementations of the disclosed subject matter, a nontransitory computer-readable medium containing computer executable instructions that, when executed by a processor, cause the processor to execute method for providing spatial audio is provided, the method comprising: receiving, from a microphone of a plurality of microphones associated with an electronic speaker device that is not paired with a media device, a plurality of microphone signals that are responsive to input audio being provided by the media device; performing directional processing on the plurality of microphone signals to produce an audio signal that corresponds with the input audio being provided by the media device; amplifying the audio signal to generate an amplified signal; and, while receiving the plurality of microphone signals, generating output audio using at least one speaker associated with the electronic speaker device in response to the amplified signal.

In accordance with some implementations of the disclosed subject matter, a system for providing spatial audio is provided, the system comprising: means for receiving, from a microphone of a plurality of microphones associated with an electronic speaker device that is not paired with a media device, a plurality of microphone signals that are responsive to input audio being provided by the media device; means for performing directional processing on the plurality of microphone signals to produce an audio signal that corresponds with the input audio being provided by the media device; means for amplifying the audio signal to generate an amplified signal; and, while receiving the plurality of microphone signals, means for generating output audio using at least one speaker associated with the electronic speaker device in response to the amplified signal.

### BRIEF DESCRIPTION OF THE DRAWINGS

FIG. 1 shows an example flow diagram of a process for providing spatial audio by synchronizing output audio from one or more speaker devices to input audio from a directional audio source in accordance with some implementations of the disclosed subject matter.

FIGS. 2A and 2B show an illustrative example of a room with audio-visual devices in accordance with some implementations of the disclosed subject matter.

FIG. 3A shows an illustrative example of an electronic speaker device having multiple microphones and/or speakers in accordance with some implementations of the disclosed subject matter.

FIG. 3B shows an illustrative example for a weighted delay and sum calculation in accordance with some implementations of the disclosed subject matter.

FIG. 4 shows an illustrative block diagram of a system that can be used to implement the mechanisms described herein in accordance with some implementations of the disclosed subject matter.

FIG. 5 shows an illustrative block diagram of hardware that can be used in a server and/or a user device of FIGS. 2A, 2B, 3A, and 4 in accordance with some implementations of the disclosed subject matter.

### DETAILED DESCRIPTION

In accordance with some implementations, mechanisms (which can include methods, systems, and media) for providing spatial audio by synchronizing output audio from one or more speaker devices to input audio from a directional audio source are provided.

Mechanisms are presented for unpaired smart speaker devices and/or other smart home devices that can be configured to provide room-scale spatial audio. By using a microphone array that is associated with each of multiple smart speaker devices, the mechanisms can beamform audio that is output from a media device speaker or other suitable audio output device associated with a media device and can configure one or more of the smart speaker devices to play the audio back in unison towards a user that is consuming the content being presented by the media device, thereby creating an immersive spatial audio experience.

For example, the mechanisms described herein can use beamforming for the one or more microphones in a microphone array within a smart speaker device or any other suitable smart home device to focus and understand audio from an audio source (e.g., a media device). Without the use of beamforming, the smart speaker would amplify all non-audio source sounds in the environment (e.g., background sounds in a room that the media device and the smart speaker devices are located).

In some implementations, the mechanisms can beamform incoming audio by using a weighted delay-and-sum principle to amplify and/or accept sounds coming from the direction of interest and reject sounds or portions of an audio signal that are not coming from the direction of interest. A calculation using the weighted delay-and-sum principle can use waveforms from multiple microphones and can multiply each waveform by a complex-valued weight. The weights (amplitude and/or phase) can be tuned to represent different distances from the audio source and/or to reject unwanted audio that is not coming from the direction of interest. In continuing this example, each weighted waveform can be included in a summation to produce a beamformed audio waveform, which can then be amplified and/or played from one or more speakers within the smart speaker device.

The beamforming approach and calculation can also be used to generate output audio that is synchronized with the audio being output by the media device (e.g., a television device). For example, in the implementation in which a smart speaker device has multiple output speakers (e.g., one or more woofers and/or one or more tweeters), the weighted delay-and-sum principle can again be used to send weighted signals to each speaker and thus produce output audio in a desired direction.

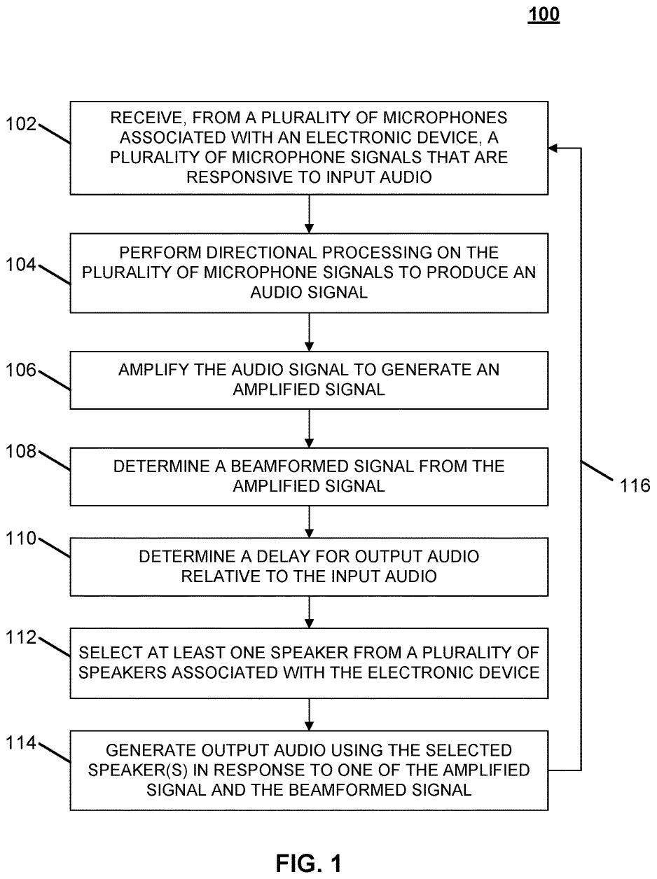

These and other features for providing spatial audio by synchronizing output audio from one or more speaker devices to input audio from a directional audio source are described further in connection with FIGS. 1-5.

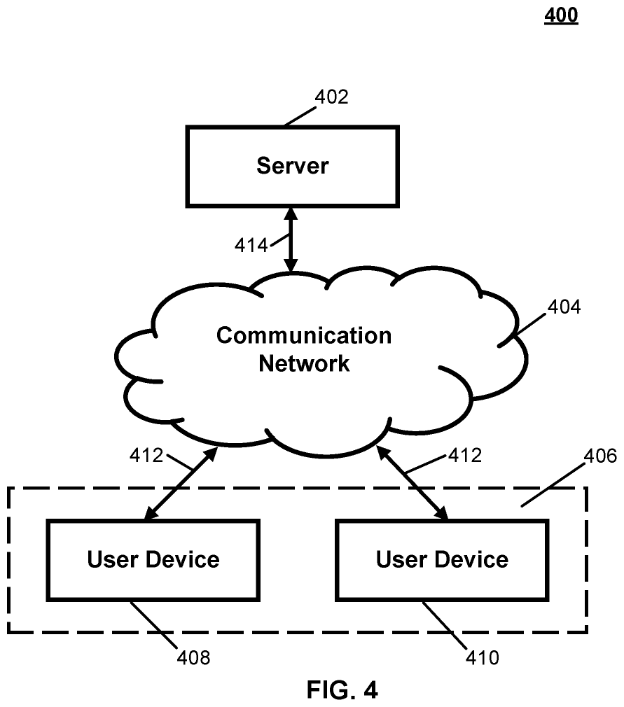

Turning to FIG. 1, an example flow diagram of an illustrative process 100 for providing spatial audio by synchronizing output audio from one or more electronic speaker devices to input audio from a directional audio source in accordance with some implementations of the disclosed subject matter is shown. In some implementations, process 100 can run on a server, such as server 402, and/or a user device, such as user devices 406, described below in connection with FIG. 4. In some implementations, process 100 can run on any device that includes at least a microphone array and/or a speaker array (e.g., a smart speaker device, an assistant device, a smart home device, etc.).

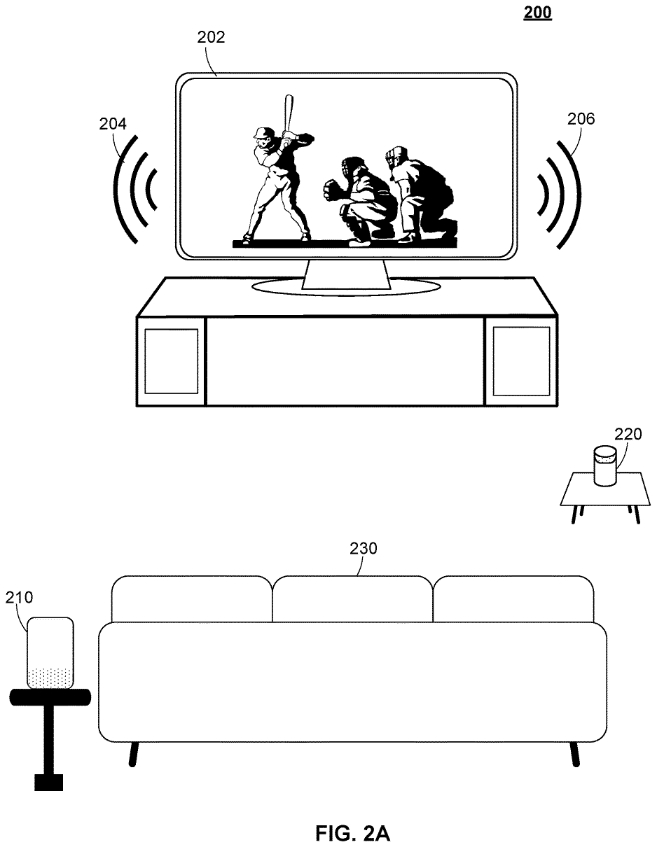

In some implementations, at 102, process 100 can receive, from a plurality of microphones associated with an electronic speaker device, a plurality of microphone signals. In some implementations, each signal in the plurality of microphone signals can be generated by a microphone in a plurality of microphones. In some implementations, the plurality of microphones can be responsive to input audio. For example, in some implementations, a media device, such as a television device, can be located in the same room as an electronic speaker device that is executing process 100, as discussed below in connections with FIGS. 2A and 2B, and a microphone array within the electronic speaker device can create microphone signals from audio detected within the room, including, but not limited to, any audio being output by the media device. In a more particular example, the electronic speaker device can be located nearby a media device that is presenting media content while not being paired or otherwise associated with the media device, where the one or more microphones in the microphone array of the electronic speaker device can detect audio that can include the audio being output by the media device is presenting the media content. In another more particular example, the electronic speaker device can be located nearby a media device that is presenting media content while not being paired or otherwise associated with the media device, where a mobile device that is executing a media setup application can instruct the media device to provide output audio (e.g., an audio clip) for detection by one or more microphones in the microphone array of the electronic speaker device.

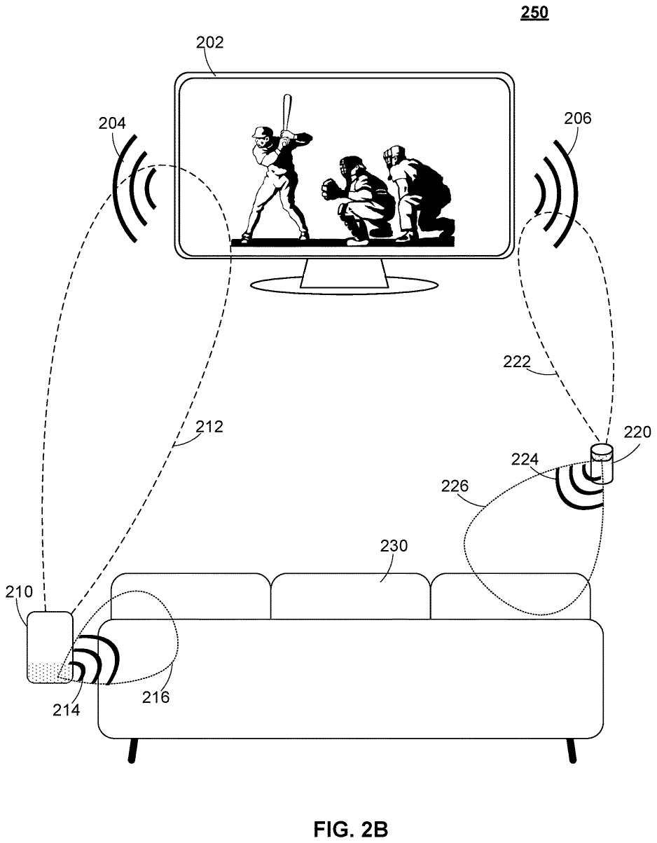

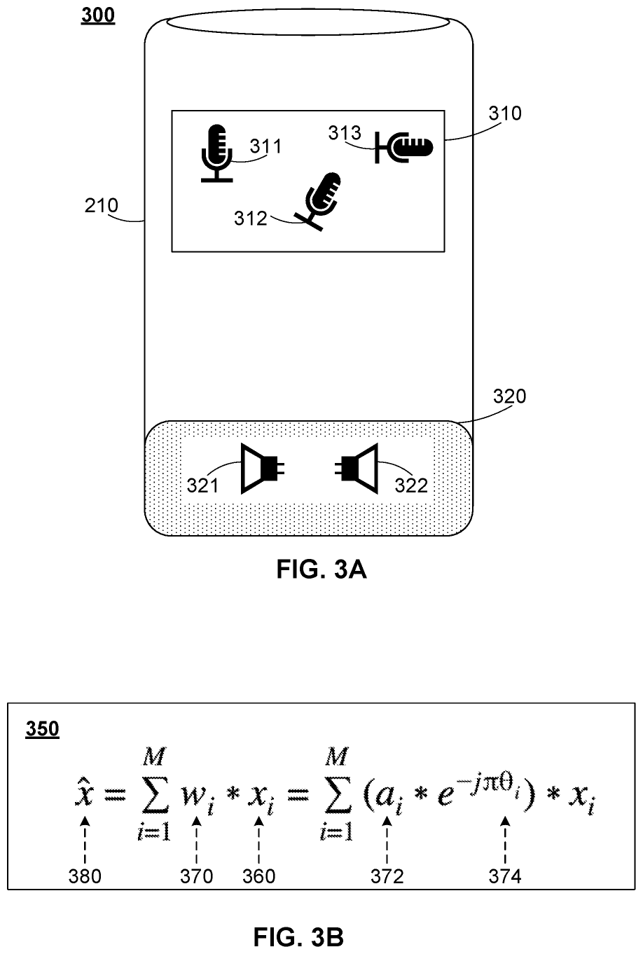

In some implementations, at 104, process 100 can perform directional processing on the plurality of microphone signals to produce an audio signal. In some implementations, directional processing can include any suitable modeling or calculation. For example, as discussed below in connection with FIGS. 3A and 3B, directional processing can include a weighted delay-and-sum calculation on the microphone signals in some implementations. In some implementations, directional processing can separate background sounds (e.g., talking, HVAC noise, pet noises, traffic noise, etc.) from sounds being produced by a nearby media device and/or any other suitable audio source.

In some implementations, at 106, process 100 can amplify the audio signal to generate an amplified signal. In some implementations, process 100 can amplify the audio signal using any suitable hardware and/or mechanisms. For example, in some implementations, process 100 can use a spectral representation (e.g., a frequency domain representation, a waveform, etc.) of the audio signal and increase the strength of the signal (e.g., adjust DC offset, increase amplitude, etc.) uniformly, above or below a specific frequency, in a specific frequency band, and/or using any other criteria.

In some implementations, process 100 can beamform incoming audio that is detected by one or more microphones of a microphone array in an electronic speaker device by using a weighted delay-and-sum algorithm that can amplify and/or accept sounds coming from the nearby media device that is in the direction of interest and reject sounds or portions of an audio signal that are not coming from the nearby media device that is in the direction of interest. For example, a calculation using the weighted delay-and-sum algorithm can use waveforms from multiple microphones in the microphone array and can multiply each waveform by a complex-valued weight. The weights based on amplitude and/or phase can be tuned to represent different distances from the audio source (e.g., the media device) and/or to reject unwanted audio that is not coming from the media device that is in the direction of interest.

In some implementations, at 108, process 100 can determine a beamformed signal from the amplified signal. In some implementations, process 100 can use a weighted delay-and-sum algorithm to form a beamformed signal from the amplified signal. In some implementations, process 100 can determine the direction of the output audio at 108 through any suitable beamforming technique. For example, in some implementations, a room with the electronic speaker device executing process 100 can have a preset target listening zone, as discussed below in connection with FIGS. 2A and 2B. In another example, a mobile device that is executing a media setup application can prompt the user to provide a verbal command or any other suitable input audio to determine a target listening zone within the environment of the media device and the one or more electronic speaker devices.

It should be noted that, in some implementations, process 100 can determine and/or manage at least two audio paths—e.g., one beamformed signal received from the media device and one beamformed signal transmitted to a target listening zone in which a user of the media device is consuming media content.

In some implementations, at 110, process 100 can calculate a delay for the output audio to be provided by the electronic speaker device that is relative to the input audio detected from the media device. In some implementations, process 100 can use any suitable information, such as a source-to-speaker distance (e.g., a media device-to-speaker device distance) to calculate any suitable delay value. In some implementations, process 100 can use a previously calculated delay value (e.g., from previous executions of process 100). For example, in some implementations, an electronic speaker device can be 1 meter away from a media device (the audio source), and process 100 can use a speed of sound of 343 meters-per-second (m/s) to calculate a 3 millisecond audio delay at 110. In some implementations, process 100 can use any suitable mechanism to determine the source-to-speaker distance.

In some implementations, a mobile device that is executing a media setup application can determine a delay for the output audio to be provided by the electronic speaker device that is relative to the input audio detected from the media device. For example, the mobile device that is executing the media setup application can instruct the media device to transmit an audio sample that is detected by the microphone array of the electronic speaker device, where the electronic speaker device executing process 100 can calculate the delay for the output audio and can generate output audio based on the detected audio sample from the media device and where the microphone array of the electronic speaker device can detect the audio sample and the generated output audio that is played back with the calculated delay to determine whether the audio sample and the generated output audio are in synchronization.

In some implementations, at 112, process 100 can select at least one speaker from a plurality of speakers associated with the electronic speaker device to provide an output. For example, in some implementations, an electronic speaker device can have a speaker array that is incorporated within the electronic speaker device, where the speaker array can produce output audio to any suitable direction. Continuing this example, in some implementations, process 100 can select a portion of the speaker array that is facing a particular direction to produce output audio. In some implementations, process 100 can select all of the speakers in the speaker array to provide output audio (e.g., in multiple directions).

Additionally or alternatively, in some implementations in which the electronic speaker device has multiple speakers of varying types, process 100 can select particular speakers within the electronic speaker device for providing an output audio signal based on audio capabilities. For example, process 100 can select tweeters on electronic speaker devices that are determined to have an audio path from the media device that is less than a threshold value and can select woofers on electronic speaker devices that are determined to have an audio path from the media device that is greater than the threshold value. In another example, process 100 can select particular speakers from electronic speaker devices based on its relative position to the media device (e.g., whether the electronic speaker device is located on the left side or the right side of the media device).

In some implementations, at 114, process 100 can produce output audio using the speakers selected at 112 and the amplified signal from 106. Additionally or alternatively, in some implementations, process 100 can use the beamformed signal from 108 and the speakers selected at 112 to produce output audio. In some implementations, process 100 can produce output audio to an output direction by sending the beamformed signal to speakers in the output direction, as discussed below in connection with FIG. 2B.

Additionally, at 114, process 100 can include any suitable audio delay, such as an audio delay calculated at 110. In some implementations, output audio produced at 114 can be synchronized to incoming audio that is provided by the media device (e.g., the output from the media device that is presenting media content).

At 116, process 100 can loop to 102 in some implementations. In some implementations, process 100 can loop at any suitable rate, and for any suitable number of iterations. In some implementations, process 100 can operate continuously while the electronic speaker device is powered on.

In some implementations, process 100 can end at any suitable time and through any suitable mechanism. For example, in some implementations, process 100 can end at 104 when directional processing produces an audio signal substantially different from a previous iteration of process 100 (e.g., the media device is turned off, the media device is playing a commercial, etc.). In another example, in some implementations, process 100 can end in response to detecting that a user has left the listening zone or a proximity of the media device and/or the electronic speaker device, and/or directs the electronic speaker device to end process 100 (e.g., powers off the electronic speaker device, selects an option from an options menu, etc.), and/or has any other suitable user interaction with the electronic speaker device.

It should be understood that at least some of the above-described blocks of process 100 can be executed or performed in any order or sequence not limited to the order and sequence shown in and described in connection with FIG. 1. Also, some of the above blocks of process 100 can be executed or performed substantially simultaneously where appropriate or in parallel to reduce latency and processing times. Additionally or alternatively, some of the above described blocks of process 100 can be omitted.

Turning to FIG. 2A, an example illustration of a room 200 with audio-visual equipment in accordance with some implementations of the disclosed subject matter is shown. In some implementations, room 200 can include equipment such as media device 202, electronic speaker devices 210 and 220, and listening zone 230.

In some implementations, media device 202 can be any suitable display device (e.g., a cathode-ray tube television, a liquid crystal display panel, a computer monitor, an organic light emitting diode (OLED) panel, a projection system, etc.) having any suitable size and/or any suitable resolution. In some implementations, media device 202 can be connected to any suitable periphery device(s) (e.g., a set-top box, a cable box, a media rendering device, a gaming console, a DVD player, a Blu-Ray disk player, a home theater, a soundbar speaker, etc.). In some implementations, media device 202 can be placed at any suitable location within room 200.

In some implementations, media device 202 can be playing any suitable media content which results in media device 202 producing audio waves 204 and 206. In some implementations, audio waves 204 and 206 can be any suitable audio at any suitable audio frequencies. In some implementations, media device 202 can produce audio waves 204 and 206 using any suitable mechanism including mechanisms not shown in FIG. 2A. For example, in some implementations, media device 202 can produce audio using built-in speakers, periphery speakers, and/or any other suitable speaker arrangement.

In some implementations, audio waves 204 and 206 can travel in any suitable direction. For example, as shown in FIG. 2A, audio wave 204 can originate from the left-hand viewing side of media device 202, and travel in a radial direction outwards in some implementations. Similarly, in another example, as shown in FIG. 2A, audio wave 206 can originate from the right-hand viewing side of television 202, and travel in a radial direction outwards in some implementations.

Note that although room 200 in FIG. 2A shows audio waves 204 and 206, in some implementations, any suitable number of audio waves can be produced by media device 202.

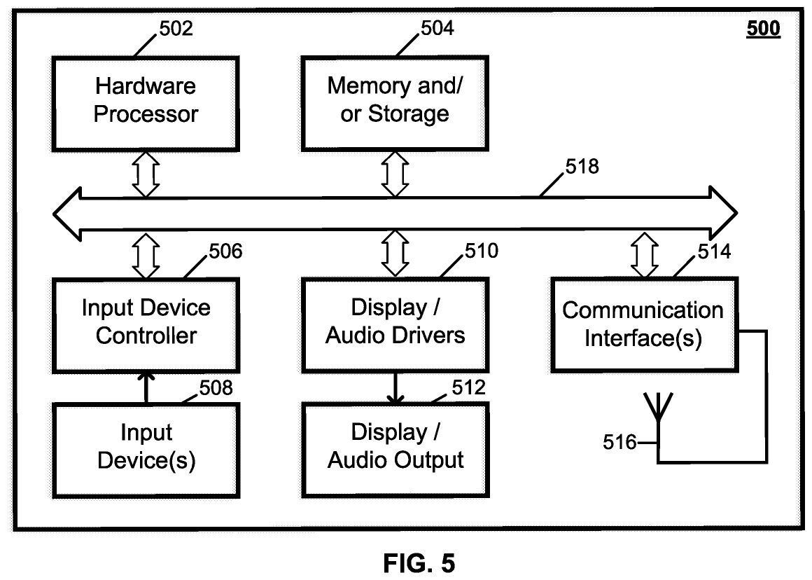

In some implementations, electronic speaker devices 210 and 220 can be any suitable computing device. In some implementations, electronic speaker devices 210 and 220 can include a microphone array, a speaker array, and/or any other suitable hardware, as discussed below in connection with FIGS. 3A and 5. In some implementations, electronic speaker devices 210 and 220 can be networked speakers (e.g., using Wi-Fi, Ethernet, etc.). In some implementations, electronic speaker devices 210 and 220 can be associated with a user account that can be used to store any suitable information relating to electronic speaker devices 210 and 220.

In some implementations, electronic speaker devices 210 and 220 can refrain from using any type of wired or wireless connection to connect with television 202. For example, in some implementations, electronic speaker device 210 and/or electronic speaker device 220 can have a Bluetooth antenna or any other suitable wireless antenna and can be unpaired or otherwise not associated with media device 202.

In some implementations, electronic speaker devices 210 and 220 can be placed at any suitable positions within room 200. For example, in some implementations, electronic speaker device 210 can be positioned in one corner of the room on a side table. Continuing this example, electronic speaker device 220 can be positioned in an opposite corner on a table of a different height, in some implementations.

Note that although room 200 in FIG. 2A shows electronic speaker devices 210 and 220, in some implementations, any suitable number of electronic speaker devices can be included in room 200. For example, in some implementations, a media setup application can allow a user to select particular electronic speaker devices to generate an audio output that is synchronized with the output being provided by media device 202.

In some implementations, listening zone 230 can be any suitable location within room 200. As illustrated in FIG. 2A, listening zone 230 can include a seating area (e.g., couch) and/or any other suitable furniture. In some implementations, listening zone 230 can be defined through any suitable mechanism. For example, in some implementations, a user can associate additional devices (e.g., phone, remote, tablet, computer, etc.) not shown in FIG. 2A with the same user account that have electronic speaker devices 210 and 220 associated. Continuing this example, in some implementations, listening zone 230 can be associated with the user account.

In a more particular example, a media setup application executing on a mobile device can allow a user to define listening zone 230 and the electronic speaker devices or any other suitable devices having one or more microphones and/or one or more speakers to produce spatial audio. In continuing this example, the media setup application executing on the mobile device can allow a user to indicate a region within listening zone 230 in which the user is positioned to consume media content from media device 202.

In some implementations, listening zone 230 can be activated by a user device (e.g., phone, remote, tablet, computer, etc.) having any suitable location capability (e.g., GPS, Bluetooth) entering a set of pre-defined coordinates that are stored and/or otherwise associated with the user account. In some implementations, listening zone 230 can be activated by a button, menu selection, and/or any other suitable user interaction on a user device. In some implementations, listening zone 230 can be activated by a voice command. For example, in some implementations, a user can direct a voice command (e.g., a wake word, a wake phrase, etc.) to electronic speaker devices 210 and/or 220, followed by any suitable voice instruction to initiate listening zone 230.

Turning to FIG. 2B, an example illustration of a room 250 with audio-visual equipment in accordance with some implementations of the disclosed subject matter is shown. In some implementations, room 250 can include equipment such as media device 202, electronic speaker devices 210 and 220, and listening zone discussed in connection with room 200 in FIG. 2A above. In some implementations, room 250 can additionally include a beamforming zone 212, an output audio 214, and a beamforming zone 216 associated with electronic speaker device 210, and/or a beamforming zone 222, an output audio 224, and a beamforming zone 226 associated with electronic speaker device 220.

In some implementations, beamforming zones 212 and 222 can correspond to a region in room 250 where microphones within electronic speaker devices 210 and 220 (respectively) can process audio from media device 202. For example, in some implementations, beamforming zone 212 can correspond to a region where microphones within electronic speaker device 210 can process audio wave 204 into microphone signals. In another example, in some implementations, beamforming zone 222 can correspond to a region where microphones within electronic speaker device 220 can process audio wave 206 into microphone signals. In some implementations, beamforming zones 212 and 222 can be any suitable size, shape, and/or volume. For example, in some implementations, beamforming zone 212 can additionally include audio wave 206 and beamforming zone 222 can include audio wave 204.

In some implementations, beamforming zones 212 and 222 can be determined during the execution of process 100. For example, in some implementations, beamforming zones 212 and 222 can be used at 104 to perform directional processing on the plurality of microphone signals.

In some implementations, beamforming zones 212 and 222 can be determined during a particular execution of process 100 to calibrate the location of media device 202 with respect to electronic speaker devices 210 and 220. In some implementations, beamforming zones 212 and 222 can be described by weights within a weighted delay-and-sum calculation. In some implementations, the weights describing beamforming zones 212 and 222 can be stored on the respective electronic speaker devices 210 and 220 and/or in any other suitable device. In some implementations, beamforming zones 212 and 222 can be described by any suitable mathematical representation and/or calculation.

In some implementations, electronic speaker device 210 can produce output audio 214 in any suitable direction. In some implementations, electronic speaker device 210 can produce output audio 214 synchronized to audio wave 204 and/or audio wave 206 from media device 202. Similarly, electronic speaker device 220 can produce output audio 224 in any suitable direction. In some implementations, electronic speaker device 220 can produce output audio 224 synchronized to audio wave 204 and/or audio wave 206 from media device 202.

In some implementations, output audio 214 and 224 can be produced from an amplified and/or beamformed signal, such as the signals discussed at 106 and 108 of process 100 described in connection with FIG. 1 above.

In some implementations, beamforming zones 216 and 226 can correspond to a region in room 250 where a speaker array within electronic speaker devices 210 and 220 (respectively) can produce output audio. For example, in some implementations, beamforming zone 216 can correspond to a region where a speaker array within electronic speaker device 210 can produce output audio 214 synchronized to audio 204. In some implementations, beamforming zone 216 can additionally be directed towards listening zone 230 and/or any other suitable direction. In another example, in some implementations, beamforming zone 226 can correspond to a region where a speaker array within electronic speaker device 220 can produce output audio 224 synchronized to audio 206. In some implementations, beamforming zone 226 can be directed towards listening zone 230 and/or any other suitable direction.

In some implementations, beamforming zones 216 and 226 can be determined during execution of process 100. For example, in some implementations, beamforming zones 216 and 226 can be calculated at 108 of process 100 as described in connection with FIG. 1 above.

In some implementations, beamforming zones 216 and 226 can be determined during a particular execution of process 100 to calibrate the location of listening zone 230 with respect to electronic speaker devices 210 and 220. In some implementations, beamforming zones 216 and 226 can be described by weights within a weighted delay-and-sum calculation. In some implementations, the weights describing beamforming zones 216 and 226 can be stored on the respective electronic speaker devices 210 and 220, and/or stored on any suitable device. In some implementations, beamforming zones 216 and 226 can be described by any suitable mathematical representation and/or calculation.

Turning to FIG. 3A, an example illustration 300 of an electronic speaker device in accordance with some implementations is shown. As illustrated, example 300 includes electronic speaker device 210, a microphone array 310, and a speaker array 320. In some implementations, electronic speaker device 210 can be any suitable speaker device, such as that described in connection with FIGS. 2A and 2B above.

In some implementations, microphone array 310 can include any suitable number of microphones. In some implementations, microphone array 310 can create any suitable microphone signals, as described at 102 of process 100 in connection with FIG. 1 above.

As illustrated, microphone array 310 can include microphones 311, 312, and 313 in some implementations. In some implementations, microphones 311, 312, and 313 can be positioned within microphone array 310 in any suitable arrangement, location, and/or orientation. In some implementations, microphone array 310 and/or microphones 311, 312, and 313 can include any other suitable hardware such as audio drivers, as discussed below in connection with FIG. 5.

In some implementations, speaker array 320 can include any suitable number of speakers. In some implementations, speaker array 320 can create any suitable output audio from an amplified and/or beamformed signal, as described at 102 of process 100 in connection with FIG. 1 above.

As illustrated, speaker array 320 includes speakers 321 and 322 in some implementations. In some implementations, speakers 321 and 322 can be positioned within speaker array 320 in any suitable arrangement, location, and/or orientation. In some implementations, speaker array 320 and/or speakers 321 and 322 can include any other suitable hardware such as audio drivers, as discussed below in connection with FIG. 5.

Turning to FIG. 3B, an example equation 350 of a beamforming calculation in accordance with some implementations is shown. As illustrated, equation 350 represents an application of a weighted delay-and-sum principle to microphone signals 360 using variable weights 370 to calculate an audio signal 380.

In some implementations, microphone signals 360 can be electronic signals produced in microphone array 310. For example, in some implementations, microphone 311 can produce a corresponding microphone signal represented in equation 350 as x₃₁₁. Continuing this example, in some implementations, microphones 312 and 313 can produce corresponding microphone signals represented in equation 350 as x₃₁₂ and x₃₁₃, respectively.

In some implementations, microphone signals 360 can be of any suitable duration. In some implementations, microphone signals 360 can be any suitable bit depth and/or audio quality.

In some implementations, weights 370 can be any suitable real-valued (positive or negative) and/or complex valued number. In some implementations, each microphone signal can have a unique weight associated with the microphone signal in equation 350. For example, in some implementations, microphone signal x₃₁₁ from microphone 311 can use weight w₃₁₁. In some implementations, weights 370 can be complex-valued and can be represented in equation 350 with an amplitude 372 and a phase 374. In some implementations, weights 370 can be used in process 100 as part of performing directional processing to produce an audio signal 380. For example, in some implementations, process 100 can adjust the values (e.g., amplitude and phase) of weights 370 so that microphone signals from microphone 311 have a stronger influence on audio signal 380 than microphone 313. In some implementations, any of the individual weights can be set or otherwise initialized to a value of 0. In some implementations, process 100 can use any suitable mechanism (e.g., machine learning models, audio models of a living room, prior calibration values, etc.) to adjust the values of weights 370.

In some implementations, audio signal 380 can be any suitable audio waveform. In some implementations, audio signal 380 can be the output from equation 350. In some implementations, audio signal 380 can be an isolated audio waveform from a direction of interest (e.g., a television show) with background sounds removed (e.g., talking, pet noises, etc.).

A practical application of equation 350 can include a weight and a microphone signal from all microphones in microphone array 310, with each weight multiplying the associated microphone signal to produce the audio signal, as shown in Equation 1 below where three terms in the weight-and-delay summation are shown as there are three microphones in microphone array 310:

$$\hat{x} = ( {w}_{311} * {x}_{311} ) + ( {w}_{312} * {x}_{312} ) + ( {w}_{313} * {x}_{313} ) \qquad ( 1 )$$

In some implementations, equation 350 can additionally represent a weighted delay-and-sum beamforming calculation to produce output audio that can be played by an array of speakers such as speakers 320. For example, in some implementations, process 100 can use equation 350 with a desired output audio as audio signal 380. In this example, in some implementations, process 100 can use weights 370 to determine speaker signals that can be sent to individual speakers 321 and 322. In some implementations, equation 350 can include any other suitable terms (e.g., a delay term) that can be used to determine speaker signals.

Turning to FIG. 4, an illustrative example 400 of hardware for providing spatial audio by synchronizing output audio from one or more speaker devices to input audio from a directional audio source in accordance with some implementations is shown. As illustrated, hardware 400 can include a server 402, a communication network 404, and/or one or more user devices 406, such as user devices 408 and 410.

Server 402 can be any suitable server(s) for storing information, data, programs, media content, and/or any other suitable content. In some implementations, server 402 can perform any suitable function(s). For example, in some implementations, server 402 can perform calculations shown in equation 350 as discussed above in connection with FIG. 3B.

Communication network 404 can be any suitable combination of one or more wired and/or wireless networks in some implementations. For example, communication network can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 406 can be connected by one or more communications links (e.g., communications links 412) to communication network 404 that can be linked via one or more communications links (e.g., communications links 414) to server 402. The communications links can be any communications links suitable for communicating data among user devices 406 and server 402 such as network links, dial-up links, wireless links, hard-wired links, any other suitable communications links, or any suitable combination of such links.

User devices 406 can include any one or more user devices suitable for use with process 100. In some implementations, user device 406 can include any suitable type of user device, such as speakers (with or without voice assistants), mobile phones, tablet computers, wearable computers, laptop computers, desktop computers, smart televisions, media players, game consoles, vehicle information and/or entertainment systems, and/or any other suitable type of user device.

Although server 402 is illustrated as one device, the functions performed by server 402 can be performed using any suitable number of devices in some implementations. For example, in some implementations, multiple devices can be used to implement the functions performed by server 402.

Although two user devices 408 and 410 are shown in FIG. 4 to avoid overcomplicating the figure, any suitable number of user devices, (including only one user device) and/or any suitable types of user devices, can be used in some implementations.

Server 402 and user devices 406 can be implemented using any suitable hardware in some implementations. For example, in some implementations, devices 402 and 406 can be implemented using any suitable general-purpose computer or special-purpose computer and can include any suitable hardware. For example, as illustrated in example hardware 500 of FIG. 5, such hardware can include hardware processor 502, memory and/or storage 504, an input device controller 506, an input device 508, display/audio drivers 510, display and audio output circuitry 512, communication interface(s) 504, an antenna 516, and a bus 518.

Hardware processor 502 can include any suitable hardware processor, such as a microprocessor, a micro-controller, digital signal processor(s), dedicated logic, and/or any other suitable circuitry for controlling the functioning of a general-purpose computer or a special-purpose computer in some implementations. In some implementations, hardware processor 502 can be controlled by a computer program stored in memory and/or storage 504. For example, in some implementations, the computer program can cause hardware processor 502 to perform functions described herein.

Memory and/or storage 504 can be any suitable memory and/or storage for storing programs, data, documents, and/or any other suitable information in some implementations. For example, memory and/or storage 504 can include random access memory, read-only memory, flash memory, hard disk storage, optical media, and/or any other suitable memory.

Input device controller 506 can be any suitable circuitry for controlling and receiving input from one or more input devices 508 in some implementations. For example, input device controller 506 can be circuitry for receiving input from a touchscreen, from a keyboard, from a mouse, from one or more buttons, from a voice recognition circuit, from one or more microphones, from a camera, from an optical sensor, from an accelerometer, from a temperature sensor, from a near field sensor, and/or any other type of input device. For example, input devices 508 can be a series of microphones such as microphone array 310.

Display/audio drivers 510 can be any suitable circuitry for controlling and driving output to one or more display/audio output devices 512 in some implementations. For example, display/audio drivers 510 can be circuitry for driving a touchscreen, a flat-panel display, a cathode ray tube display, a projector, a speaker or speakers, and/or any other suitable display and/or presentation devices. For example, display/audio drivers 510 can be used in connection with microphone array 310 and/or speaker array 320. In another example, in some implementations, display/audio drivers 510 can include circuitry for amplifying audio signals at 106 of process 100, as described in connection with FIG. 1 above.

Communication interface(s) 514 can be any suitable circuitry for interfacing with one or more communication networks, such as network 404 as shown in FIG. 4. For example, interface(s) 514 can include network interface card circuitry, wireless communication circuitry, and/or any other suitable type of communication network circuitry.

Antenna 516 can be any suitable one or more antennas for wirelessly communicating with a communication network (e.g., communication network 404) in some implementations. In some implementations, antenna 516 can be omitted.

Bus 518 can be any suitable mechanism for communicating between two or more components 502, 504, 506, 510, and 514 in some implementations.

Any other suitable components can be included in hardware 500 in accordance with some implementations.

In some implementations, any suitable computer readable media can be used for storing instructions for performing the functions and/or processes described herein. For example, in some implementations, computer readable media can be transitory or non-transitory. For example, non-transitory computer readable media can include media such as non-transitory forms of magnetic media (such as hard disks, floppy disks, etc.), non-transitory forms of optical media (such as compact discs, digital video discs, Blu-ray discs, etc.), non-transitory forms of semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative implementations, it is understood that the present disclosure has been made only by way of example, and that numerous changes in the details of implementation of the invention can be made without departing from the spirit and scope of the invention, which is limited only by the claims that follow. Features of the disclosed implementations can be combined and rearranged in various ways.

1. A method, the method comprising:
receiving, from a microphone of a plurality of microphones associated with an electronic speaker device that is not paired with a media device, a plurality of microphone signals that are responsive to input audio being provided by the media device;
performing directional processing on the plurality of microphone signals to produce an audio signal that corresponds with the input audio being provided by the media device;
amplifying the audio signal to generate an amplified signal; and
while receiving the plurality of microphone signals, generating output audio using at least one speaker associated with the electronic speaker device in response to the amplified signal.

2. The method of claim 1, wherein generating the output audio using the at least one speaker associated with the electronic speaker device in response to the amplified signal further comprises selecting a speaker from a plurality of speakers that are included in the electronic speaker device.

3. The method of claim 1, wherein generating the output audio using the at least one speaker associated with the electronic speaker device in response to the amplified signal further comprises:
determining a beamformed signal from the amplified signal that corresponds with a listening zone in an environment that includes the media device and the electronic speaker device; and
causing a plurality of speakers within the electronic speaker device to produce the output audio corresponding to the beamformed signal.

4. The method of claim 1, wherein performing directional processing further comprises performing a first weighted delay and sum calculation on the plurality of microphone signals to separate the input audio being provided by the media device from background audio signals.

5. The method of claim 4, wherein the first weighted delay and sum calculation further comprises complex valued weights comprising an amplitude and a phase.

6. The method of claim 4, wherein the first weighted delay and sum calculation further comprises weights determined in a second weighted delay and sum calculation.

7. The method of claim 1, wherein the input audio comprises a set of audio tones produced from one or more locations, and wherein the method further comprises:
in response to performing directional processing on the plurality of microphone signals to produce the audio signal, causing a plurality of weights to be determined, wherein the plurality of weights correspond to the one or more locations; and
causing the plurality of weights to be stored in the electronic speaker device.

8. An electronic speaker device that provides spatial audio, wherein the electronic speaker device comprises:
a plurality of microphones;
a plurality of speakers; and
a hardware processor that is configured to:
receive, from a microphone of the plurality of microphones associated with the electronic speaker device that is not paired with a media device, a plurality of microphone signals that are responsive to input audio being provided by the media device;
perform directional processing on the plurality of microphone signals to produce an audio signal that corresponds with the input audio being provided by the media device;
amplify the audio signal to generate an amplified signal; and
while receiving the plurality of microphone signals, generate output audio using at least one speaker associated with the electronic speaker device in response to the amplified signal.

9. The electronic speaker device of claim 8, wherein generating the output audio using the at least one speaker associated with the electronic speaker device in response to the amplified signal further comprises causing the hardware processor to select a speaker from a plurality of speakers that are included in the electronic speaker device.

10. The electronic speaker device of claim 8, wherein generating the output audio using the at least one speaker associated with the electronic speaker device in response to the amplified signal further comprises:
determining a beamformed signal from the amplified signal that corresponds with a listening zone in an environment that includes the media device and the electronic speaker device; and
causing a plurality of speakers within the electronic speaker device to produce the output audio corresponding to the beamformed signal.

11. The electronic speaker device of claim 8, wherein the hardware processor is further configured to perform a first weighted delay and sum calculation on the plurality of microphone signals to separate the input audio being provided by the media device from background audio signals.

12. The electronic speaker device of claim 11, wherein the first weighted delay and sum calculation further comprises complex valued weights comprising an amplitude and a phase.

13. The electronic speaker device of claim 11, wherein the first weighted delay and sum calculation further comprises weights determined in a second weighted delay and sum calculation.

14. The electronic speaker device of claim 8, wherein the input audio comprises a set of audio tones produced from one or more locations, and wherein the hardware processor is further configured to:
in response to performing directional processing on the plurality of microphone signals to produce the audio signal, cause a plurality of weights to be determined, wherein the plurality of weights correspond to the one or more locations; and
cause the plurality of weights to be stored in the electronic speaker device.

15. A non-transitory computer-readable medium containing computer executable instructions that, when executed by a processor, cause the processor to execute method for providing spatial audio, the method comprising:
receiving, from a microphone of a plurality of microphones associated with an electronic speaker device that is not paired with a media device, a plurality of microphone signals that are responsive to input audio being provided by the media device;
performing directional processing on the plurality of microphone signals to produce an audio signal that corresponds with the input audio being provided by the media device;
amplifying the audio signal to generate an amplified signal; and
while receiving the plurality of microphone signals, generating output audio using at least one speaker associated with the electronic speaker device in response to the amplified signal.

16. The non-transitory computer-readable medium of claim 15, wherein generating the output audio using the at least one speaker associated with the electronic speaker device in response to the amplified signal further comprises selecting a speaker from a plurality of speakers that are included in the electronic speaker device.

17. The non-transitory computer-readable medium of claim 15, wherein generating the output audio using the at least one speaker associated with the electronic speaker device in response to the amplified signal further comprises:
determining a beamformed signal from the amplified signal that corresponds with a listening zone in an environment that includes the media device and the electronic speaker device; and
causing a plurality of speakers within the electronic speaker device to produce the output audio corresponding to the beamformed signal.

18. The non-transitory computer-readable medium of claim 15, wherein performing directional processing further comprises performing a first weighted delay and sum calculation on the plurality of microphone signals to separate the input audio being provided by the media device from background audio signals.

19. The non-transitory computer-readable medium of claim 18, wherein the first weighted delay and sum calculation further comprises complex valued weights comprising an amplitude and a phase.

20. The non-transitory computer-readable medium of claim 18, wherein the first weighted delay and sum calculation further comprises weights determined in a second weighted delay and sum calculation.

21. The non-transitory computer-readable medium of claim 15, wherein the input audio comprises a set of audio tones produced from one or more locations, and wherein the method further comprises:
in response to performing directional processing on the plurality of microphone signals to produce the audio signal, causing a plurality of weights to be determined, wherein the plurality of weights correspond to the one or more locations; and
causing the plurality of weights to be stored in the electronic speaker device.
